(19) United States
(12) Patent Application Publication
(10) Pub. No.: US 2003/0014859 A1
(43) Pub. Date: Jan. 23, 2003

(54) Method of automated hybrid lithium-ion cells production and method of the cell assembly and construction

(76) Inventors: Joseph B. Kejha, Meadowbrook, PA (US); David Chua, Wayne, PA (US); Hsiu-Ping Lin, Princeton, NJ (US)

Correspondence Address: JOSEPH B. KEJHA, 1022 FREDERICK RD., MEADOWBROOK, PA, 19046, US

(21) Appl. No.: 10/119,220

(22) Filed: Apr. 9, 2002

Related U.S. Application Data
(63) Continuation-in-part of application No. 09/911,036, filed on Jul. 23, 2001.

(51) Int. Cl. H01M 10/04

(52) U.S. Cl. 29/623.4; 29/623.5

(57) ABSTRACT

The present invention pertains to hybrid lithium-ion based electrochemical devices having a thin microporous polymeric separator bonded to their porous electrodes without special treatment of the separator and without additional adhesive layers. Structures of superior high energy density and power density are disclosed herein, as well as the methods of their assembly and automated production.

### CROSS REFERENCE TO RELATED DOCUMENTS

The subject matter of the invention is shown and described in the Disclosure Document of Joseph B. Kejha Ser. No. 490,145 filed on Mar. 8, 2001, and entitled “Automated Lithium-Polymer Cells Production and Method of Cell Assembly and Construction.” This application is also a continuation in part of the Application of Joseph B. Kejha at al., Ser. No. 09/911,036 filed on Jul. 23, 2001, and entitled, “Manufacturing Method and Structure of Electrodes for Lithium Based Electrochemical Devices”.

### BACKGROUND OF THE INVENTION

1. Field of the Invention

This invention pertains mostly to automated production, assembly and construction of hybrid lithium-ion polymer electrochemical devices, such as hybrid lithium-ion batteries or capacitors, and more specifically the devices which have a microporous polymer film separator adhesively joined to the electrodes, and used as a carrier of cells through the assembly process.

2. Description of the Prior Art

Prior art lithium polymer cells and their plasticized electrodes are usually heat welded (laminated) together by a plasticized PVDF polymer film separator sandwiched therebetween as described in the U.S. Pat. No. 5,587,253 of Gozdz at al. This separator is too soft and must be thick to prevent shorts, which decreases the energy density. Another method employs a thin, specially treated polypropylene or polyethylene microporous Celgard separator as is disclosed in the U.S. Pat. No. 6,322,923B1 of Spotnitz at al., which is precoated by a layer of plasticized polyvinylidene fluoride hexafluoropropylene (PVDF/HFP) copolymer by propylene carbonate (PC). The treated Celgard separator is then similarly heat welded (laminated) to the plasticized electrodes, as is disclosed in the U.S. Pat. No. 6,328,770B1. The preferred “plasticizer” is really PVDF-HFP latent solvent, PC. In both methods, the plasticizer must be then extracted by a flammable non-solvent bath of the cells.

Another cell assembly method and structure of Yoshida at al., as described in the U.S. Pat. No. 6,291,102B1 employs coating of the Celgard separator on both sides or the electrodes with a polymeric adhesive, which then holds the cell together. However, all these methods add a thickness to the cell due to additional layers, and partially close, or restrict the separator pores, which increases the cell resistance, and decreases the energy density.

All the cells are then vacuum dried, soaked by a liquid non-aqueous electrolyte, and sealed in a lightweight and soft, moisture-proof pouch.

All the above prior art methods are very labor intensive with many steps, and therefore costly.

The liquid electrolyte lithium-ion prismatic, or rolled cell, or capacitor comprises non-plasticized (dry) electrodes coated on solid metal foils and a Celgard microporous polymer separator, stacked or rolled between them, but not welded or glued. Whole cell assembly is held together only by a sealed hard casing, and the cell is also soaked by an electrolyte.

The hard casings are usually heavy and the prismatic cells or capacitors have size limitations, due to limited stiffness of the casing and its ability to maintain pressure on the stack. The heavy casing decreases the energy density. The metal foil current collectors seal the surface of the electrodes and restrict soaking of the cell by the electrolyte, and the soaking must be therefore done under vacuum, which is costly.

Automated production of liquid electrolyte prismatic, or rolled electrochemical devices requires a complex and expensive robotic machinery for handling of the loose components and assemblies.

Prior art automated lithium polymer electrochemical devices production methods utilize the first electrode length and the plasticized solid polymer separator film length as a carrier of the cells through the assembly process. The prior art solid polymer separator length may have also a composite structure, having embedded-in various nets, as shown in the U.S. Pat. No. 5,102,752, or the separator may be coated on one of the electrodes and then is partially solidified. The second electrode, cut into spaced leafs is then added and the separator is then fully solidified. In the above examples, the polymer of the separators is used as the adhesive, which holds the cells together after the solidification, or the plasticized free film separator is fully solidified, and then heat welded to the electrodes in one or two laminating steps. The resulting assembly length is then cut into individual cells between the second electrode leafs.

Prior art lithium polymer cells production methods and cell structures require, or result in having a relatively thick separator, due to the soft polymer, non-uniform coating, and/or thick net, which decreases the energy density of the cells, and makes them non-competitive in this respect with the liquid electrolyte prismatic cells having thin and tough Celgard separator. However, the prismatic and rolled cells have heavy casings. Therefore, the “ideal cell” is of hybrid construction, in which the porous dry electrodes without plasticizer and extraction steps are adhesively joined with a thin, microporous, tough and proven Celgard microporous separator, without adding a thickness to the cell, and which cell therefore does not require a heavy hard casing, can be easily activated by an electrolyte without the use of vacuum, and may be packaged in a lightweight pouch. The hybrid cells' construction, and the method of their easy, automated production of this invention, which combines only the best features of the polymer cells and the liquid electrolyte cells, do not suffer from prior art problems and provide superior energy density and many other positive advantages.

### SUMMARY OF THE INVENTION

It has now been found, that a hybrid lithium-ion polymer cell, capacitor, or other electrochemical chemical devices can by made by bonding their electrodes to a microporous, polymer, tough and thin film separator without the separator special treatment or polymer precoating, or without using a polymeric adhesive layer(s). The preferred separator is Celgard 2500 of polypropylene, as manufactured by Celgard LLC, Charlotte, N.C., but the invention is not limited only to this separator and polymer type. Similar products made by Goretex, Ashahi Chemical Industry, UBE Ind., Nitto Denko and others are also suitable.

It has been found, that the adhesion of the electrodes to the separator is caused by welding or bonding the polymeric binder of the electrodes directly to the separator surface. Therefore, no additional layer(s) or thickness is added, or is necessary to the cell laminate. The preferred binder of the electrodes is polyvinylidene fluoride (PVDF) homopolymer, or a PVDF copolymer. These binders adhere to the polypropylene, or other polymer microporous separator even if they are of dissimilar polymers. Other polymeric binders are also usable. The principle of this invention is to use any binder of the electrodes or in the electrodes structure to bond also the electrodes to the separator.

The preferred electrodes are non-plasticized, porous (dry) electrodes, coated on porous, expanded metal foil, or solid foil, as described in our prior patent application Ser. No. 09/911,036, which is herein incorporated by reference.

To promote adhesion to the hard and dry non-plasticized electrodes, the separator is simply dip-soaked prior to weld (laminating) by a high boiling point aprotic liquid as butylene carbonate, gamma-butyrolactone, ethylene carbonate, N-methyl pyrrolidinone, various glycols preferably having boiling point about or less than 240° C., tetraglyme, or their mixtures.

All the above aprotic liquids are harmless to the cell electrolyte or chemistry, if traces of them are left in the cell. The aprotic liquids may be also mixed with a low viscosity thinner, like methanol, tetrahydrafuran, dimethyl carbonate, diethyl carbonate and the like. The function of the thinner is to lower the viscosity of the mixture, so the Celgard separator accepts the liquid and is soakable. These thinners are also removed before or after the weld-laminating or bonding step.

The function of the aprotic liquid in the separator is to lower the melting point of the electrodes binder at the interfaces, and also to fill the separator and thus to prevent its collapsing under the heat weld-laminating pressure.

The heat welding temperature of the laminating step should be set close, but not higher than melting point of the porous polymer separator, to prevent closing of its pores. It has been also found, that in the automated cells production, the micro porous separator may be used as the aprotic liquid carrier, and the cells carrier through the assembly process.

The separator may be dip-soaked by the aprotic liquid and then horizontally fed into nip-rollers of a horizontal laminator with top and bottom heat plates and a pair of pressure rollers.

Two single cells' electrodes may be simultaneously cut into leafs and fed into the same nip-rollers in a synchronized manner, so they line up on top and bottom of the separator, with a lengthwise space between them. Whole assembly may be then laminated by preheating it in the heat plates and then welding it together by preferably compliant pressure rollers, having preferably a steel roller on the bottom and a rubber roller on the top.

On the top and bottom of the electrodes are also release films or papers, or belts fed through the same nip-rollers, plates and pressure rollers, to carry the bottom electrodes and to prevent a misalignment of the electrodes, while traveling through the laminator heat plates. These release films maybe also arranged as endless belts, or maybe “spool to spool” unwinded and winded.

The laminated single cells assembly length may be then wound onto a spool, or cut between the cells into individual cells and stacked, or several cells may be “Z” folded by bending the separator only in the linear spaces between the cells, and then cut between the cell packs.

Similarly, an automated bi-cells production can be made by feeding the single cells assembly length from the spool, for the second time through the laminator and by feeding on the top of the single cells' second electrodes the second soaked porous separator, and cutting and feeding third electrode leafs into the nip-rollers in a synchronized manner, so they line up with the single cells' second electrodes, and then weld-laminating them together.

The resulting laminated bi-cell's assembly length may be then similarly cut or folded as described for the single cells production.

The laminated single or bi-cells, single or bi-cell packs, or other lithium-ion based electrochemical devices, may be than vacuum dried, inserted under inert atmosphere into thin and lightweight moistureproof pouches or casings, activated by a liquid electrolyte, and sealed.

The principal object of this invention is to provide a more reliable hybrid lithium-ion based cell or electrochemical device construction, which has a superior energy density, power density and easier automated assembly over the prior art.

Another object of this invention is to provide simpler, less costly, automated production method of lithium-ion based electrochemical devices over the prior art. Other objects and advantages of the invention will be apparent from the description and claims.

### BRIEF DESCRIPTION OF THE DRAWINGS

The nature and characteristic features of the invention will be more readily understood from the following descriptions taken in connection with the accompanying drawing forming part hereof in which:

FIG. 1 is a diagrammatic, side elevational, sectional view of the single cell, illustrating its components and their layers.

FIG. 2 is a top elevational view of the single cell, illustrating terminal tabs, electrodes and separator sizing, and their overlying relationship.

FIG. 3 is a diagrammatic, side elevational, sectional view of the bi-cell, illustrating its components and their layers.

FIG. 4 is a top elevational view of the bi-cell, illustrating terminal tabs, electrodes and separator sizing, and their overlying relationship.

FIG. 5 is a diagrammatic, side elevational view of the single cell assembly machine, illustrating its various components and their locations.

FIG. 6 is a diagrammatic, side elevational view of the bi-cell assembly machine, illustrating its various components and their locations.

Like numerals refer to like parts throughout the several views and figures. It should, of course, be understood that the description and the drawings herein are merely illustrative, and it will be apparent that various modifications, combinations and changes can be made of the structures and the systems disclosed without departing from the spirit of the invention and from the scope of the appended claims.

### DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function in substantially the same way to bring about the same results.

Lithium based electrochemical devices and for example lithium-ion-polymer prismatic battery cell usually comprises, two flat electrodes, each with metal foil current collectors on the outside, and a polymer electrolyte separator between the electrodes. The separator is in the polymer type cell welded or adhesively joined to both electrodes and holds the cell together.

The present invention employs a novel cell structure and a simpler and more reliable method for manufacturing of the cells, which structure and method result in improved cells with many advantages.

Referring now in more detail, particularly to the drawings of this patent and FIGS. 1 and 2, one embodiment of this invention is the hybrid lithium-ion polymer single cell 1 comprising: The first electrode layer 2 which may be an anode, having embedded in porous copper grid current collector 3 with a terminal tab 4; one mil thin microporous polymer separator layer 5, which is non-plasticized, and may be of polypropylene, such as manufactured by Celgard LLC, Charlotte, N.C.; and the second electrode layer 6, which may be a cathode, having embedded-in a porous aluminum grid current collector 7 with a terminal tab 8.

The separator 5 is simply heat welded or bonded(laminated) in one step by a controlled heat and pressure roller laminator, or a controlled hot press with compliant plates (not shown), directly to the surfaces of the electrodes 2 and 6, without any special separator surface treatment, or precoating with polymeric adhesive layers.

The preferred separator is Celgard 2500 of polypropylene, but the invention is not limited only to this separator and polymer type. Other porous polymers, such as polyethylene, polyvinylalcohol, polycarbonate,and their alloys or copolymers are also suitable, as well as the separators made by other manufacturers like Goretex, Ashahi, Entek and others. Multi-layer, multi-polymer separators are also useable.

The adhesion is achieved only by the polymeric binder of the electrodes, which melts under the laminating heat and pressure, and resolidifies, and bonds to the separator by subsequent cooling to room temperature. Therefore, no additional layers or thickness is/are added to the cell, or are necessary.

The preferred binder of the electrodes is polyvinylidene fluoride (PVDF) homopolymer, or a polyvinylidene fluoride copolymer. These binders adhere to the polypropylene or other porous polymer separator even if they are dissimilar polymers. Other polymeric binders may be also suitable.

The principle of the invention is to use ay binder of electrodes and/or in the electrodes to bond also the electrodes to the separator.

The preferred electrodes are non-plasticized, porous (dry) electrodes, having porous expanded or solid metal foil current collectors and a PVDF based binder, as described in our prior patent application Ser. No. 09/911,036, which is herein incorporated by reference.

In a single cell—at least one electrode should have the porous metal current collector, and in a bi-cell—at least two electrodes should have the porous metal current collectors, to facilitate easy drying and activation by a liquid electrolyte.

To promote adhesion to the hard and dry non-plasticized electrodes,preferably only the separator 5 is simply dip-soaked prior to welding or bonding (laminating) by a high boiling point aprotic liquid, which is later evaporated after the cell welding or bonding, by drying and/or heating the cell in a vacuum chamber (not shown). The electrodes may be also soaked by the liquid, prior to said bonding.

The preferred high boiling point aprotic liquids are butylene carbonate, gamma-butyrolactone, ethylene carbonate, N-methyl pyrrolidinone, various glycols preferably having boiling point about or less than 240° C., tetraglyme, or their mixtures.

The reason why aprotic liquids are used is because the above aprotic liquids are harmless to the cell electrolyte or chemistry, if small amounts or traces of them are left in the cell. The aprotic liquids may be also mixed with a low boiling point, low viscosity thinner, like methanol, tetrahydrafuran, dimethyl carbonate, diethyl carbonate and the like. The function of the thinner is to lower the viscosity of the mixture, so the microporous separator accepts the liquid and is soakable (wettable). These thinners are also removed before or after the weld-laminating or bonding step.

The function of the aprotic liquid in the separator is to lower the melting point of the electrode's binder by contact at the interfaces, and also to fill the separator and thus to prevent its collapsing under the weld-laminating pressure.

The heat welding or bonding temperature of the laminating step should be set close to but not higher than melting point of the microporous polymer separator, to prevent closing or collapsing of its pores.

It should be noted, that plasticized electrodes are also suitable for the cell assembly.

### Example #1 of Single Cell Preparation

a. Several cathode current collectors were cut into sections from aluminum expanded micro grid (Exmet Corp.), and surface treated as described in our patent application Ser. No. 09/911,036. Cathode slurry of desired viscosity with PVDF homopolymer binder and without any plasticizer was prepared according to the same patent application, containing LiCoO₂ as the active material, and a carbon. The current collectors were partially, vertically hand-dipped into the slurry, then slowly pulled upward, suspended on a rack, and then vacuum dried in vacuum oven at approximately 100° C. for 2 hours.

b. Similarly, several anode current collectors were cut into sections from copper expanded micro grid (Exmet Corp.), surface treated, identically hand dip-coated by anode slurry of desired viscosity and without any plasticizer, containing mesocarbon microbeads (MCMB) as the active material, a carbon, and PVDF homopolymer as the binder, suspended and similarly vacuum dried.

c. All above electrodes were then cut into the same size sections,( having uncoated terminal tabs as shown in FIG. 2), weighed, marked and kept in separate anode and cathode groups.

d. Untreated Celgard 2500 micro porous 25 microns thin separator (as sold for use in liquid electrolyte cells by Celgard, LLC) was cut into a section slightly larger in latelar dimensions than the electrodes, and then was submerged into a mixture of aprotic liquid N-methylpyrrolidinone and 30% of methanol, which mixture soaked into the separator.

e. One anode and one matching cathode electrodes were selected for the cell assembly from their groups, based on their substantially similar capacities, calculated from their active material weights.

f. Both electrodes were inserted into silicone release paper folders and hot callendered by a commercial goldsmith's roller press, to reduce their thickness by about 10-30%.

g. The soaked microporous separator from the step “d”, was then sandwiched between the electrodes in overlying relation, as shown in FIGS. 1 and 2, and whole assembly was inserted into a folder of polyester films and fed into a commercial, heated, compliant pressure roller laminator, set to about 110° C.-120° C. temperature, which welded and/or bonded the cell assembly together, without damaging the separator.

h. The resulting cell was then placed for 2 hours into a vacuum oven, set at about 45° C. temperature, to dry out the aprotic liquid mixture and then the cell was dried under approx. 30″Hg vacuum at room temperature for 8 hours, before activation under inert atmosphere by a well known liquid electrolyte containing, 1 Mole LiPF₆ salt, and sealing in a plastic coated metal foil pouch, with sealed terminal tabs protruding out from the pouch. The cell was rechargeable.

### Example #2 of Single Cell Preparation

a. Metal micro grids of both electrodes, as described in the Example #1 were identically cut, treated and dip-coated, except at this time by well known plasticized active materials slurries of desired viscosity with PVDF/HFP binder as described in prior art patents, but the slurries contained gamma-butyrolactone instead of the conventional dibutyl phalate (DBP). The coated grids were suspended and dried in air at room temperature, cut into identical sections, and callendered, as described in the Example #1.

b. Untreated Celgard 2500 microporous separator, as described in the Example #1, step “d” was submerged into mixture of aprotic liquid gamma-butyrolactone and 30% methanol.

c. The separator from the step “b” of this Example #2 was sandwiched between the plasticized, matching electrodes in overlying relation, as shown in FIGS. 1 and 2, and was heat welded and/or bonded to the electrodes, similarly as described in the Example #1, and without damaging the separator.

d. The resulting cell was then placed into (3) consecutive extraction baths of methanol for ½ hour each, which extracted the gamma-butyrolactone. The cell was then dried under 30″ Hg vacuum at room temperature for 8 hours, before the same activation and packaging, as described in the Example #1, and was rechargeable.

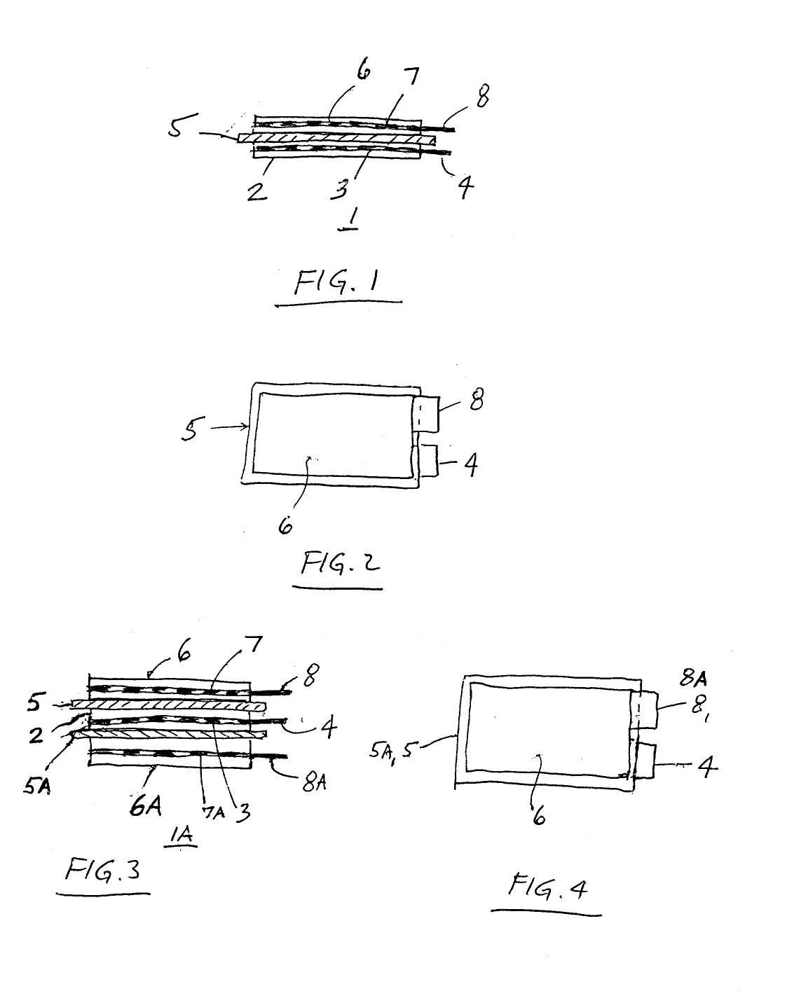

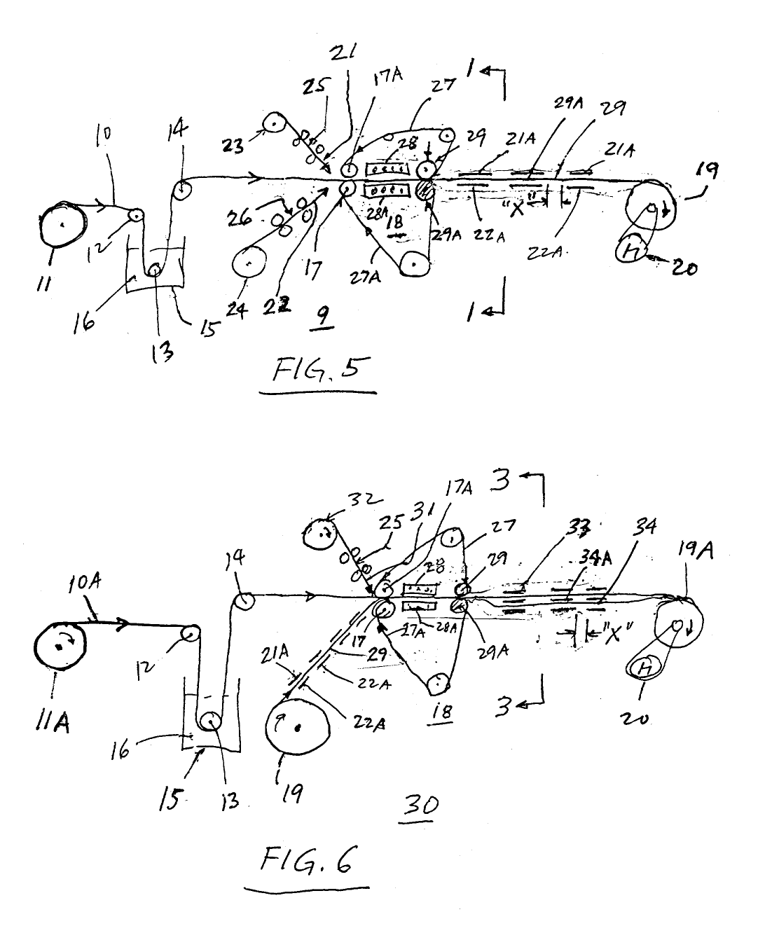

Another embodiment of the invention is illustrated in FIGS. 3 and 4, showing the hybrid lithium-ion polymer bi-cell 1A comprising: The first electrode layer 2, which may be an anode, having embedded-in the middle a porous copper perforated foil current collector, or a solid copper foil current collector 3 with the terminal tab 4; the first, 1 mil thin and microporous polymer separator 5, the same separator as described in the single cell; the second electrode layer 6, which may be a cathode having embedded-in a porous aluminum grid current collector 7 and the terminal tab 8; the second porous polymer separator layer 5A, identical to the described separator layer 5; and the third electrode layer 6A, which may be the second cathode, identical to the layer 6, having embedded-in a porous aluminum grid current collector 7A with terminal tab 8A.

This bi-cell may be similarly prepared and heat welded or bonded (laminated) together in one or two steps, like is described for the single cell 1 above, while using the same materials, methods, and tools.

Similarly, a stacked multicell, multilayer electrochemical device can be bonded together, having at least two electrodes and at least one microporous separator, but the electrodes and the separators may be in virtually unlimited numbers. A hot press with compliant plates may be used for said bonding.

It should be noted that for other electrochemical devices, the current collectors' metals should be selected to be compatible with the particular cell chemistry and voltage.

The advantage of the bi-cell is in having only one anode current collector 3, which reduces the total weight per capacity, and thus results in a higher energy density than of the single cell. However, both cells of the invention have higher energy density and rate capability over the prior art polymer cells or liquid electrolyte cells, due to their thinner separator, less total thickness, lightweight enclosure, and due to having the metal grid current collectors embedded in the middle of their electrodes by dip-coating, as described in our prior patent application Ser. No. 09/911,036.

Referring now to FIG. 5, illustrating the automated single cells assembly machine 9, and the method of the automated hybrid single cells production, which is another embodiment of the invention.

The microporous Celgard separator length 10 is used as the aprotic liquid carrier, and the cells carrier through the assembly process, in which the separator length 10 is unwound from the spool 11 and is pulled over the rollers 12,13, and 14 through the dip-tank 15 with the aprotic liquid 16, which liquid soaks into the separator length 10, and the separator length 10 is then fed into the nip-rollers 17 and 17A of the heat and pressure roller type laminator 18, pulled through by and wound onto spool 19, driven by motor 20.

The single cell's electrodes' lengths anode 21, and cathode 22, may be unwound from the spools 23 and 24, through the metering cutters 25 and 26, such as used in photoprocessing, and maybe simultaneously cut into the leafs 21 and 21A and fed into the same nip-rollers 17 and 17A in a synchronized manner, so they line-up on top and bottom of the separator length 10 with a lengthwise spaces “x” between them. On top and bottom of the electrodes' leafs 21A and 22A are also release films, or papers, or endless belts 27 and 27A fed into nip-rollers 17 and 17A, heat plates 28 and 28A, and pressure rollers 29 and 29A, to carry the bottom electrodes 22A and to prevent a misalignment of the electrodes, while traveling through the heat plates 28 and 28A. These release films maybe arranged as endless belts, or may be “spool to spool” unwound and wound (not shown). Whole cell's assembly length 29 is laminated by preheating it in the heat plates 28 and 28A and then welding or bonding it together by the compliant pressure rollers 29 and 29A. The roller 29A may be preferably made of steel and the roller 29 may be preferably having a rubber surface. The pressure may be achieved by airsprings or by other means. The laminated single cells assembly length 29 may be then wound onto the spool 19, or may be cut (in spaces “x”) into individual cells and stacked into cell packs, or several cells may be “Z” folded in the linear spaces “x” between the cells, and then cut between the cell packs (not shown).

The laminator 18 may have also a separate drive motor (not shown), for driving nip-rollers 17 and 17A and pressure rollers 29 and 29A, either synchronized with the motor 20, or the motor 20 may have an overdrive with a slip clutch (not shown).

In the sectional view “1-1”, the single cell 29A looks like the cell 1 in FIG. 1. It should be noted that the tabs 4 and 8 as shown in FIG. 2 may be cut, or notched-out on an automatic notcher prior to feeding the electrodes 21 and 22 into the cutters 25 and 26.

Referring now to FIG. 6, illustrating the automated bi-cells assembly machine 30 and the method of the automated hybrid bi-cells production, which is another embodiment of the invention.

Similarly, the single cells assembly length 29 may be fed from the spool 19 for the second time through the laminator 18 and the second micro porous separator length 10A soaked in the aprotic liquid 16 and may be fed onto the nip-rollers 17 and 17A on the top of the single cell's anodes 21A, and the third electrode (such as the second cathode) length 31 may be unwound from the spool 32, fed through the metering cutter 25 and may be cut into the leafs 33 and fed into the same nip-rollers 17 and 17A in a synchronized manner, so they line-up with the single cell's anodes 21A, and weld-laminate them all together. The resulting laminated bi-cells assembly length 34 may be similarly wound onto the spool 19A, or cut into individual bi-cells 34A, which may be stacked into bi-cell packs, or “Z” folded, as described for the single cells production.

In the sectional view “3-3”, the bi-cell 34A looks like the bi-cell 1A in FIG. 3. The terminal tabs 8A, as shown in FIG. 4 may be also notched-out prior to feeding the electrode 31 into the cutter 25.

Of course, the bi-cell assembly can be also reversed, having the cathode in the middle and two anodes on the outsides, and may be similarly automatically or manually assembled and weld-laminated or bonded together. Similarly, additional layers may be also added and bonded.

The laminated single cells or bi-cells, or single or bi-cell packs, capacitors, or other lithium-ion based electrochemical devices may be then electrically connected, vacuum dried, to dry-out the aprotic liquid and moisture, and inserted under an inert atmosphere into thin walled and lightweight pouches or casings, activated by a liquid non-aqueous electrolyte, and sealed.

It should, of course be understood that the description and the drawings herein are merely illustrative and it will be apparent that various modifications, combinations and changes can be made of the structures and the systems disclosed without departing from the spirit of the invention and from the scope of the appended claims.

It will thus be seen that a more economical and reliable method for lithium-ion based electrochemical devices manufacturing, and improved cells' structures have been provided with which the objects of the invention are achieved.

We claim:

1. A manufacturing method of lithium-ion based single cell electrochemical device comprising the steps of:
providing a first porous electrode structure having an active material with a carbon and a polymeric binder coated on both sides of a porous metal current collector;
providing a second porous electrode structure having an active material with a carbon and a polymeric binder coated on both sides of a porous metal current collector;
providing a soaked microporous polymeric separator by an aprotic liquid;
bonding said separator between said first electrode structure and said second electrode structure by said binders of said electrodes;
and drying out said aprotic liquid.

2. A manufacturing method of lithium-ion based bi-cell electrochemical device comprising the steps of:
providing a first porous electrode structure having an active material with carbon and a polymeric binder coated on both sides of a porous metal current collector;
providing a second porous electrode structure having an active material with a carbon and a polymeric binder coated on both sides of a porous metal current collector;
providing a third porous electrode structure having an active material with a carbon and a polymeric binder coated on both sides of a porous metal current collector;
providing a first soaked microporous polymeric separator by an aprotic liquid;
providing a second soaked microporous polymeric separator by an aprotic liquid;
bonding said first separator between said first electrode structure and said second electrode structure, and said second separator between said second electrode structure and said third electrode structure by said binders of said electrodes;
and drying out said aprotic liquid.

3. A manufacturing method of lithium-ion based bi-cell electrochemical device comprising the step of:
providing a first porous electrode structure having an active material with a carbon and a polymeric binder coated on both sides of a porous metal current collector;
providing a second porous electrode structure having an active material with carbon and a polymeric binder coated on both sides of a solid metal foil current collector;
providing a third porous electrode structure having an active material with a carbon and a polymeric binder coated on both sides of a porous metal current collector;
providing a first soaked microporous polymeric separator by an aprotic liquid;
providing a second soaked microporous polymeric separator by an aprotic liquid;
bonding said first separator between said first electrode structure and said second electrode structure, and said second separator between said second electrode structure and said third electrode structure by said binders of said electrodes;
and drying out said aprotic liquid.

4. A structure of lithium-ion based electrochemical device comprising at least two porous electrodes having an active material with a carbon and a polymeric binder coated on both sides of porous metal current collectors of said electrodes; and
at least one microporous polymeric separator bonded between said electrodes by said binders of said electrodes.

5. A manufacturing method of automated production of a plurality of lithium-ion based single cell electrochemical devices which comprises:
providing a first porous electrode length having an active material with a carbon and a polymeric binder coated on a porous metal current collector with spaced terminal tabs thereon;
providing a second porous electrode length having an active material with a carbon and a polymeric binder, coated on a porous metal current collector with spaced terminal tabs thereon;
providing first microporous polymeric separator length;
soaking said separator length in an aprotic liquid;
cutting said first electrode and said second electrode lengths into leafs with said terminal tabs thereon;
assembling said first electrode leafs and said second electrode leafs onto said separator length in spaced and synchronized and overlying relation;
bonding together by heat and pressure said first electrode leafs, said separator length and said second electrode leafs into a layered assembly in overlying relation, with said first separator length between said first electrode leafs and said second electrode leafs, wherein said first separator length, said first electrode leafs and said second electrode leafs are assembled in synchronized relation to form single cells layered assembly length;
winding said layered assembly length onto a spool;
or cutting said assembly length between said leafs to form individual single cells; and
drying out said aprotic liquid, stacking, electrically connecting, activating and packaging said cells.

6. A manufacturing method of automated production of a plurality of lithium-ion based bi-cell electrochemical devices which comprises:
providing a single cells' layered assembly length as described in claim 5;
providing a third porous electrode length having an active material with a carbon and a polymeric binder coated on a porous metal current collector with spaced terminal tabs thereon;
providing second microporous separator length;
soaking said second separator length in an aprotic liquid;
cutting said third electrode into leafs with said terminal tabs thereon;
assembling said single cells' layered assembly length and said second separator length in overlaying relation, and assembling said third electrode leafs onto said second separator length in spaced and synchronized and overlaying relation;
bonding together by heat and pressure said second electrode leafs, said second separator length and said third electrode leafs into a layered assembly in overlying relation, with said second separator length between said second electrode leafs and said third electrode leafs, wherein said second electrode leafs and said third electrode leafs, are assembled in synchronized relation to form bi-cell's layered assembly length;
winding said layered assembly length onto a spool;
or cutting said assembly length between said leafs to form individual bi-cells;
and drying out said aprotic liquid, stacking, electrically connecting, activating and packaging said cells.

7. A manufacturing method of lithium-ion based electrochemical devices as described in claims 1, or 2, or 3, or 5, or 6, in which said aprotic liquid is selected from the group consisting of gamma-butyrolactone, ethylene carbonate, butylene carbonate, N-methylpyrrolidinone, glycols, and their mixtures.

8. A manufacturing method of lithium-ion based electrochemical devices as described in claim 1, or 2, or 3, or 5 , or 6, in which said aprotic liquid additionally includes a low viscosity liquid thinner.

9. A manufacturing method and structure of lithium-ion based electrochemical devices as described in claims 1, or 2, or 3, or 4, or 5, or 6, in which said binders are selected from the group consisting of polyvinylidene fluoride homopolymers, polyvinylidene fluoride hexafluoropropylene copolymers, and their alloys.

10. A manufacturing method of lithium-ion based electrochemical devices as described in claims 1, or 2, or 3, or 5, or 6, in which said bonding step includes a controlled temperature and pressure, which do not cause collapse of said separator.

11. A manufacturing method as described in claims 1, or 2, or 3, or 5 or 6, in which said bonding step includes controlled temperature and said temperature is lower than the melting point of said separators' material.

12. A manufacturing method as described in claims 1, or 2, or 3 or 5, or 6, in which said bonding step includes controlled pressure and said pressure is produced by a compliant roller.

13. A manufacturing method as described in claims 1, or 2, or 3, or 5, or 6, in which said bonding step includes controlled pressure and said pressure is produced by a compliant plate.

14. A manufacturing method and structure as described in claims 1, or 2, or 3, or 4, or 5, or 6, in which said coated active materials with a carbon and polymeric binder are dip-coated on said metal current collectors.

15. A manufacturing method and structure as described in claims 1, or 2, or 3, or 4, or 5, or 6, in which said porous metal collectors are selected from expanded metal foils, metal microgrids, metal grids, and perforated metal foils.

16. A manufacturing method and structure as described in claims 1, or 2, or 3, or 4, or 5, or 6, in which said microporous polymer separator material selected from the group consisting of polypropylene, polyethylene, polyvinylalcohol, polycarbonate, and their alloys and copolymers.

17. A manufacturing method and structure as described in claims 1, or 2, or 3, or 4, or 5, or 6, in which said device is a rechargeable lithium-ion cell.

18. A manufacturing method and structure as described in claims 1, or 2, or 3, or 4, or 5, or 6, in which said device is an electrochemical capacitor.
